(19) United States
(12) Patent Application Publication
(10) Pub. No.: US 2026/0360942 A1
(43) Pub. Date: Nov. 12, 2026

(54) BATTERY CELL INCLUDING BUNDLE OF ELECTRODE ASSEMBLY AND METHOD FOR MANUFACTURING THE SAME

(71) Applicant: SK On Co., Ltd., Seoul (KR)

(72) Inventors: Chang Mook HWANG, Daejeon (KR); Do Hee KWON, Daejeon (KR); Min Cheol KIM, Daejeon (KR); Su Ung CHAE, Daejeon (KR)

(21) Appl. No.: 19/675,319

(22) Filed: May 12, 2026

(30) Foreign Application Priority Data
May 12, 2025 (KR) 10-2025-0061165
Mar. 13, 2026 (KR) 10-2026-0045801

(51) Int. Cl. H01M 50/536; H01M 10/0587; H01M 50/105; H01M 50/15; H01M 50/169; H01M 50/533; H01M 50/538

(52) U.S. Cl. CPC H01M 50/536; H01M 10/0587; H01M 50/105; H01M 50/15; H01M 50/169; H01M 50/533; H01M 50/538

(57) ABSTRACT

The present disclosure relates to an electrode assembly bundle, a battery cell including the same, and a method for manufacturing the same. For example, an electrode assembly bundle including a plurality of electrode assemblies comprises: a first electrode assembly; a second electrode assembly arranged in parallel with the first electrode assembly; and a tab bundle including a plurality of first tabs protruding from one side or both sides of the first electrode assembly and a plurality of second tabs protruding from one side or both sides of the second electrode assembly, wherein the tab bundle may include a preliminary welding portion at which the plurality of first tabs and the plurality of second tabs are bonded to each other in a partial region of the tab bundle.

### CROSS-REFERENCE TO RELATED PATENT APPLICATION

The present application claims priority under 35 U.S.C. § 119(a) to Korean patent application number 10-2025-0061165, filed on May 12, 2025, and Korean patent application number 10-2026-0045801, filed on Mar. 13, 2026, in the Ministry of Intellectual Property, the entire disclosure of which is incorporated herein by reference.

### BACKGROUND OF THE DISCLOSURE

### 1. Field

The present disclosure relates to an electrode assembly bundle, a battery cell including the same, and a method for manufacturing the same.

### 2. Description of the Related Art

As the price of energy sources increases due to depletion of fossil fuels and concerns about environmental pollution are amplified, the demand for eco-friendly alternative energy sources has become an indispensable factor for future life, and in particular, as technology development and demand for mobile devices increase, the demand for secondary batteries as energy sources is rapidly increasing.

For example, a secondary battery may include an electrode assembly in which separator is interposed between electrode plates and stacked or wound, a case accommodating the electrode assembly together with an electrolyte, and a cap assembly sealing the case. Such an electrode assembly has tabs (uncoated tabs) protruding in a lateral or upper direction, and after gathering the tabs to one side and bending the tabs over a current collector, the tabs and the current collector may be laser welded. Alternatively, the tabs may be gathered to one side and pressed onto the current collector, and then laser welded.

However, during laser welding, the performance of the secondary battery may be affected depending on the welding quality between the tabs and the current collector.

Accordingly, there is a need for technology development of a battery cell including an electrode assembly bundle and a method for manufacturing the same that can improve the welding efficiency between the tabs and the current collector.

### SUMMARY OF THE DISCLOSURE

According to an aspect of the present disclosure, an object is to provide a battery cell including an electrode assembly bundle and a method for manufacturing the same that can improve the adhesion between the tabs and the current collector during the manufacturing process of the secondary battery.

According to another aspect of the present disclosure, an object is to provide a battery cell including an electrode assembly bundle and a method for manufacturing the same that can improve the welding efficiency between the tabs and the current collector during the manufacturing process of the secondary battery.

According to another aspect of the present disclosure, an object is to improve the quality of the battery cell during the manufacturing process of the secondary battery.

Meanwhile, the battery cell including an electrode assembly bundle and the method for manufacturing the same according to the present disclosure can be widely applied in green technology fields, such as electric vehicles, battery charging stations, energy storage systems (ESS), and photovoltaics, wind power, and the like that use battery cells.

In addition, the battery cell including an electrode assembly bundle and the method for manufacturing the same according to the present disclosure can be used in eco-friendly mobility including electric vehicles and hybrid vehicles for preventing climate change by suppressing air pollution and greenhouse gas emissions.

The present disclosure relates to an electrode assembly bundle including a plurality of electrode assemblies, wherein the electrode assembly bundle includes: a first electrode assembly; a second electrode assembly arranged in parallel with the first electrode assembly; and a tab bundle including a plurality of first tabs protruding from one side or both sides of the first electrode assembly and a plurality of second tabs protruding from one side or both sides of the second electrode assembly, and wherein the tab bundle may include a preliminary welding portion at which the plurality of first tabs and the plurality of second tabs are bonded to each other in a partial region of the tab bundle.

In an embodiment of the present disclosure, the tab bundle may include: an overlapping portion including a first overlapping portion where the plurality of first tabs overlap with each other and a second overlapping portion where the plurality of second tabs overlap with each other; a facing portion where the plurality of first tabs extending from the first overlapping portion and the plurality of second tabs extending from the second overlapping portion face each other; a connection portion extending from the facing portion; and a bent portion disposed between the facing portion and the connection portion, at which the plurality of first tabs and the plurality of second tabs are bent.

In an embodiment of the present disclosure, the preliminary welding portion may further include: a first preliminary welding portion formed by welding the plurality of first tabs and the plurality of second tabs in at least a partial region of the facing portion; and a second preliminary welding portion formed by welding the plurality of first tabs and the plurality of second tabs in at least a partial region of the connection portion, and the bent portion may be disposed between the first preliminary welding portion and the second preliminary welding portion.

In an embodiment of the present disclosure, the second preliminary welding portion may include a cut portion formed by cutting a region of the second preliminary welding portion.

In an embodiment of the present disclosure, a battery cell includes: an outer casing; at least one electrode assembly bundle as described above and accommodated in the outer casing; and a cap assembly coupled to one side of the outer casing.

In an embodiment of the present disclosure, the tab bundle includes: an overlapping portion including a first overlapping portion where the plurality of first tabs overlap with each other and a second overlapping portion where the plurality of second tabs overlap with each other; a facing portion where the plurality of first tabs extending from the first overlapping portion and the plurality of second tabs extending from the second overlapping portion face each other; a connection portion extending from the facing portion; and a bent portion disposed between the facing portion and the connection portion, at which the plurality of first tabs and the plurality of second tabs are bent, and the connection portion may be electrically connected to the cap assembly.

In an embodiment of the present disclosure, the preliminary welding portion may further include: a first preliminary welding portion formed by welding the plurality of first tabs and the plurality of second tabs in at least a partial region of the facing portion; and a second preliminary welding portion formed by welding the plurality of first tabs and the plurality of second tabs in at least a partial region of the connection portion, the bent portion may be disposed between the first preliminary welding portion and the second preliminary welding portion, and the second preliminary welding portion may be electrically connected to the cap assembly.

In an embodiment of the present disclosure, the battery cell further includes a current collector electrically connected to the cap assembly, and the tab bundle includes: an overlapping portion including a first overlapping portion where the plurality of first tabs overlap with each other and a second overlapping portion where the plurality of second tabs overlap with each other; a facing portion where the plurality of first tabs extending from the first overlapping portion and the plurality of second tabs extending from the second overlapping portion face each other; a connection portion extending from the facing portion; and a bent portion disposed between the facing portion and the connection portion, at which the plurality of first tabs and the plurality of second tabs are bent, and the connection portion may be electrically connected to the current collector.

In an embodiment of the present disclosure, the preliminary welding portion may further include: a first preliminary welding portion formed by welding the plurality of first tabs and the plurality of second tabs in at least a partial region of the facing portion; and a second preliminary welding portion formed by welding the plurality of first tabs and the plurality of second tabs in at least a partial region of the connection portion, the bent portion may be disposed between the first preliminary welding portion and the second preliminary welding portion, and the second preliminary welding portion may be electrically connected to the current collector.

In an embodiment of the present disclosure, a method for manufacturing a battery cell includes: preparing a plurality of electrode assemblies including a first electrode assembly and a second electrode assembly; arranging the first electrode assembly and the second electrode assembly adjacent to each other in parallel; aligning a plurality of first tabs protruding from one side or both sides of the first electrode assembly and a plurality of second tabs protruding from one side or both sides of the second electrode assembly so as to face each other to form a tab bundle; and welding a partial region of the tab bundle to form a preliminary welding portion.

In an embodiment of the present disclosure, the preliminary welding portion may include: a first preliminary welding portion formed by welding the plurality of first tabs and the plurality of second tabs in at least a partial region of the tab bundle; and a second preliminary welding portion formed by welding the plurality of first tabs and the plurality of second tabs in a partial region spaced apart by a predetermined distance from the first preliminary welding portion toward distal ends of the plurality of first tabs and the plurality of second tabs.

In an embodiment of the present disclosure, the method further includes: preparing a welding guide including a slit open at one side; and inserting the tab bundle into the slit while disposing the welding guide in parallel with end portions of the first electrode assembly and the second electrode assembly, and the first preliminary welding portion may be formed by welding a region of the tab bundle exposed to an outside of the welding guide.

In an embodiment of the present disclosure, a distance from the end portions of the first electrode assembly and the second electrode assembly to the first preliminary welding portion may be greater than or equal to a thickness change amount of the first electrode assembly and the second electrode assembly due to use of the battery cell.

In an embodiment of the present disclosure, the second preliminary welding portion may include a cut portion formed by cutting a region of the second preliminary welding portion.

In an embodiment of the present disclosure, the method further includes: preparing an outer casing accommodating the first electrode assembly and the second electrode assembly and a cap assembly coupled to one side of the outer casing; and electrically connecting a terminal portion of the cap assembly and the second preliminary welding portion.

In an embodiment of the present disclosure, the method further includes: preparing a current collector configured to electrically connect with the first electrode assembly and the second electrode assembly; and electrically connecting the second preliminary welding portion to the current collector.

In an embodiment of the present disclosure, the current collector is disposed between the first preliminary welding portion and the second preliminary welding portion, the tab bundle includes a curved portion curved toward the current collector between the first preliminary welding portion and the second preliminary welding portion, and the second preliminary welding portion may be electrically connected to a surface of the current collector.

According to an embodiment of the present disclosure, the welded tabs can be prevented from being folded or torn during the manufacturing process of the secondary battery.

According to another embodiment of the present disclosure, weldability between the tabs and the current collector can be secured during the manufacturing process of the secondary battery.

According to another embodiment of the present disclosure, disconnection of the tabs due to expansion of the secondary battery during use of the secondary battery can be prevented.

In addition, according to another embodiment of the present disclosure, since the thickness of the current collector and the cap assembly can be reduced during the manufacturing process of the secondary battery, the energy density of the battery assembly can be improved.

### BRIEF DESCRIPTION OF THE DRAWINGS

FIG. 1 is an exploded perspective view schematically illustrating a battery assembly according to an embodiment of the present disclosure.

FIG. 2 is a perspective view schematically illustrating a first tab bundle of a first electrode assembly and a second tab bundle of a second electrode assembly according to an embodiment of the present disclosure.

FIG. 3 is a perspective view schematically illustrating welding of a tab bundle of electrode assemblies to a current collector according to an embodiment of the present disclosure.

FIG. 4 is a perspective view schematically illustrating a welding guide according to an embodiment of the present disclosure.

FIGS. 5A-5C are schematic diagrams schematically illustrating formation of a first preliminary welding portion and a second preliminary welding portion according to an embodiment of the present disclosure.

FIG. 6 is an enlarged view of a portion A of FIG. 5A.

FIGS. 7A and 7B are schematic diagrams schematically illustrating welding of a tab bundle to a current collector according to an embodiment of the present disclosure, and expansion of first and second electrode assemblies.

### DETAILED DESCRIPTION

Hereinafter, embodiments of the present application will be described in detail with reference to the accompanying drawings so that those of ordinary skill in the art to which the present application pertains can readily practice the same. However, the present application can be implemented in various different forms and is not limited to the embodiments described herein. Also, in the drawings, portions irrelevant to the description are omitted for clarity of description, and similar reference numerals are used for similar portions throughout the specification.

In the present disclosure, "secondary battery" may refer to a battery cell.

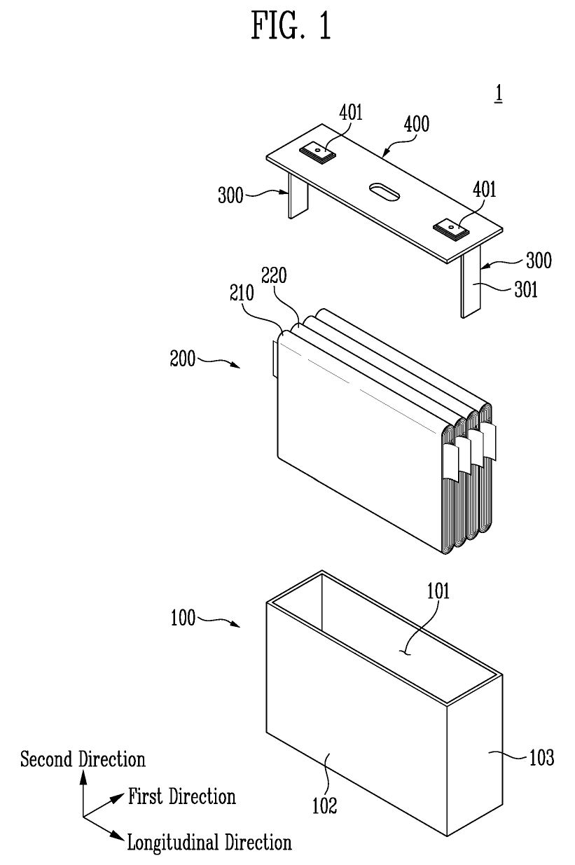

For example, the secondary battery may be classified into a pouch-type secondary battery, a prismatic secondary battery, or a cylindrical secondary battery depending on the shape. Referring to FIG. 1, for convenience of description, a prismatic secondary battery is illustrated as an example in the present specification, but the present disclosure is not limited thereto.

Also, an electrode assembly may refer to an assembly of electrodes stacked in a structure of positive electrode plate/separator/negative electrode plate in a laminate sheet outer casing, and for example, the secondary battery according to an embodiment may include a jelly-roll type electrode assembly in which the electrode assembly is wound in a roll form.

Meanwhile, the tabs may have a structure in which the tabs are drawn out to an outside of a sheet and extend in the same direction or an opposite direction. For example, the tabs may be formed in a plurality, and the plurality of tabs may be arranged in parallel with each other to form a tab bundle. For example, the tab bundle may protrude in both directions from an outside of one jelly-roll electrode assembly, or a plurality of tab bundles may be formed in one direction from an outside of one jelly-roll electrode assembly. Also, a plurality of tab bundles may be formed in one direction from an outside of one jelly-roll electrode assembly, and a plurality of tab bundles may also be formed in another direction.

The secondary battery may be a jelly-roll type secondary battery having a structure in which an electrode assembly having electrode plates stacked in a structure of positive electrode plate/separator/negative electrode plate in a laminate sheet outer casing is wound and built in a state connected with electrode tabs formed on an outside of the electrode assembly. In addition, the tabs of the electrode may have a structure in which the tabs are drawn out to an outside of a sheet and extend in the same direction or an opposite direction.

Also, in the present disclosure, the secondary battery includes battery cells and batteries.

Hereinafter, a battery assembly 1 according to various embodiments of the present disclosure will be described in more detail through the drawings.

FIG. 1 is an exploded perspective view schematically illustrating a battery assembly 1 according to an embodiment of the present disclosure.

In an embodiment of the present disclosure, an electrode assembly bundle 200 including a plurality of electrode assemblies 210 and 220 may include a first electrode assembly 210, a second electrode assembly 220 arranged in parallel with the first electrode assembly 210, and a tab bundle 230 including a plurality of first tabs 211 protruding from one side or both sides of the first electrode assembly 210 and a plurality of second tabs 221 protruding from one side or both sides of the second electrode assembly 220. Also, the tab bundle 230 may include a preliminary welding portion 231 and 234 at which the plurality of first tabs 211 and the plurality of second tabs 221 are bonded to each other in a partial region of the tab bundle 230.

For example, the battery assembly 1 may include a plurality of electrode assemblies 210 and 220, an outer casing 100 accommodating the plurality of electrode assemblies 210 and 220, and a cap assembly 400 coupled to the outer casing 100. Illustratively, the battery assembly 1 may be a prismatic battery cell in which the outer casing 100 has a rectangular parallelepiped shape. However, this is merely an example, and the present disclosure can be applied to a battery assembly having outer casings of various forms.

For example, the electrode assemblies 210 and 220 may be formed by winding or stacking a unit laminate body composed of thin plate-shaped or film-shaped electrode plates and a separator interposed therebetween. When the electrode assemblies 210 and 220 are formed by winding, a winding axis may be disposed in a horizontal direction approximately parallel to a longitudinal direction of the cap assembly 400 or in a vertical direction approximately perpendicular to the longitudinal direction of the cap assembly 400. When the electrode assemblies 210 and 220 are formed by stacking, the plurality of unit laminate bodies may be arranged such that long side surfaces of the plurality of unit laminate bodies are adjacent to each other.

For example, the present disclosure may include a welding system, and the welding system of a battery assembly according to an embodiment of the present disclosure may include electrode assemblies 210 and 220 in which electrode plates and separators are stacked and which include a plurality of tabs 211 and 221 protruding from one side or both sides of the electrode plates and which are accommodated in the internal space; a current collector 300 electrically connected to the plurality of tabs 211 and 221; and a laser welding device 600 configured to weld the plurality of tabs 211 and 221 and the current collector 300 to each other. Also, the electrode assemblies 210 and 220 may include a tab bundle 230 in which the plurality of tabs 211 and 221 are aligned.

For example, the electrode plates of the battery assembly 1 may be provided in a plurality, and among the plurality of electrode plates, a first electrode plate may be a negative electrode and a second electrode plate may be a positive electrode. Alternatively, the configuration may be reversed.

For example, when the first electrode plate is a negative electrode plate, the first electrode plate may be formed by applying a first electrode active material, such as graphite or carbon, on a first electrode current collector provided as a metal foil, such as copper, a copper alloy, nickel, or a nickel alloy. A first uncoated portion, which is a region where the first electrode active material is not applied, may be formed on the first electrode plate. Since the first uncoated portion serves as a tab electrically connected to a first current collector among a plurality of current collectors 300 that can be disposed on one side of both side directions of the battery assembly 1, the first uncoated portion may be defined as a first tab 211. The plurality of first tabs 211 may be aligned and bent to one side and welded to the first current collector (this will be described later). The first current collector may be electrically connected to the cap assembly 400.

For example, when the second electrode plate is a positive electrode plate, the second electrode plate may be formed by applying a second electrode active material, such as a transition metal oxide, on a second electrode current collector provided as a metal foil, such as aluminum or an aluminum alloy. A second uncoated portion, which is a region where the second electrode active material is not applied, may be formed on the second electrode plate. Since the second uncoated portion is disposed on the other side of the both side directions of the battery assembly 1 described above and serves as a tab electrically connected to a second current collector that can be disposed on an opposite side of the first current collector, the second uncoated portion may be defined as a second tab 221. The plurality of second tabs 221 may be bent to one side and welded to the second current collector. The second current collector may be electrically connected to the cap assembly 400.

For example, the separator is disposed between the first electrode plate and the second electrode plate to prevent short circuits and to enable migration of lithium ions. For example, the separator may be a single porous polymer film made of a polyolefin-based polymer, such as an ethylene homopolymer, a propylene homopolymer, an ethylene/butene copolymer, an ethylene/hexene copolymer, or an ethylene/methacrylate copolymer, or a laminated form including these films. As another example, the separator may use a conventional porous non-woven fabric, such as a non-woven fabric made of high-melting-point glass fiber, polyethylene terephthalate fiber, or the like.

In an embodiment of the present disclosure, the plurality of electrode assemblies 210 and 220 may be formed by winding the above-described first electrode plate, the second electrode plate, and the separator interposed between the first electrode plate and the second electrode plate with a winding axis in the longitudinal direction, which is the direction in which the first tab 211 or the second tab 221 protrudes, and then pressing the wound electrode assemblies to be flat and flattened, as illustrated in FIG. 1.

For example, the outer surfaces of the plurality of electrode assemblies 210 and 220 may each include two surfaces arranged in parallel with the winding axis, two curved surfaces curving between the two surfaces, and side surfaces formed by stacking end portions of the electrode plates and the separator in a plurality and arranged perpendicular to the longitudinal direction. Also, an additional separator may be provided on each outer surface of the plurality of electrode assemblies 210 and 220 for insulation from the outer casing 100.

In an embodiment of the present disclosure, the plurality of electrode assemblies 210 and 220 may be accommodated in the outer casing 100 together with an electrolytic solution. In some examples, the electrolytic solution may include a lithium salt, such as LiPF6 or LiBF4, in an organic solvent, such as EC (ethylene carbonate), PC (propylene carbonate), DEC (diethyl carbonate), EMC (ethylmethyl carbonate), or DMC (dimethyl carbonate). Also, the electrolytic solution may be in a liquid or gel state. In some embodiments, when an inorganic solid electrolyte is used, the electrolytic solution may be omitted.

As illustrated in FIG. 1, in an embodiment of the present disclosure, the outer casing 100 may have an approximately rectangular parallelepiped box shape with an upper portion in the longitudinal direction being open and an internal space 101 being formed therein. The plurality of electrode assemblies 210 and 220 and the electrolytic solution may be accommodated inside the outer casing 100 through the open upper portion. Some components of the cap assembly 400 may be exposed to an outside of the outer casing 100, and some components may be accommodated in the internal space 101 of the outer casing 100.

For example, when a surface having a relatively large area among side surfaces of the outer casing 100 is defined as a long side portion 102 and a surface having a relatively small area is defined as a short side portion 103, one outer surface of the first electrode assembly 210 among the plurality of electrode assemblies 210 and 220 may be arranged to face the long side portion 102, and as described above, when a direction in which the tabs protrude from the electrode plates is defined as a longitudinal direction, the second electrode assembly 220 may be arranged adjacent to the first electrode assembly 210 in a first direction perpendicular to the longitudinal direction so as to face the first electrode assembly 210. Also, a third electrode assembly and a fourth electrode assembly may be sequentially arranged adjacent to the second electrode assembly 220.

In an embodiment of the present disclosure, with the plurality of electrode assemblies 210 and 220 accommodated in the outer casing 100, the cap assembly 400 may be coupled to the outer casing 100 and electrically connected to the plurality of electrode assemblies 210 and 220.

In an embodiment of the present disclosure, the cap assembly 400 may have an approximately rectangular plate shape and may be formed of the same material as the outer casing 100. The cap assembly 400 may include a plurality of terminal portions 401 electrically connected to the current collector 300 and an electrolyte injection hole for injecting the electrolytic solution.

Also, in another embodiment of the present disclosure, an insulating plate (not illustrated) may be provided between the plurality of electrode assemblies 210 and 220 and the cap assembly 400 for insulation therebetween.

Also, in an embodiment of the present disclosure, the current collector 300 may electrically connect the first electrode plate, which is the negative electrode plate, or the second electrode plate, which is the positive electrode plate, with the terminal portion 401 of the cap assembly 400. For example, the current collector 300 may be made of the same material as the electrode plates and may have an approximately rectangular shape.

For example, when two pairs of electrode assemblies are accommodated in the outer casing 100 and each tab bundle 230 from each electrode assembly 210 and 220 is bent and welded from both sides of the current collector 300, the current collector 300 may have a U-shape including two sub-current collectors to which the respective tab bundles 230 are welded.

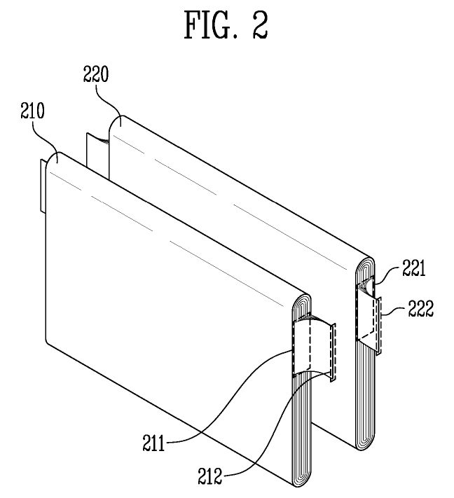

FIG. 2 is a perspective view schematically illustrating a first tab bundle 212 of a first electrode assembly 210 and a second tab bundle 222 of a second electrode assembly 220 according to an embodiment of the present disclosure.

The battery cell according to an embodiment of the present disclosure may include an outer casing, at least one electrode assembly bundle 200 accommodated in the outer casing, and a cap assembly 400 coupled to one side of the outer casing.

For example, the electrode assembly bundle 200 may be formed in a plurality, and the electrode assemblies 210 and 220 may include the first electrode assembly 210 arranged in the first direction perpendicular to the longitudinal direction, when a protruding direction of the protruding tabs is defined as the longitudinal direction, and the second electrode assembly 220 arranged adjacent to the first electrode assembly 210 in parallel with each other. Specifically, although not illustrated, for example, a third electrode assembly, a fourth electrode assembly, and the like may additionally be arranged adjacent to the second electrode assembly 220.

For example, the first electrode assembly 210 and the second electrode assembly 220 may face each other.

In an embodiment of the present disclosure, the tab bundle 230 may include an overlapping portion including a first overlapping portion where the plurality of first tabs 211 overlap with each other and a second overlapping portion where the plurality of second tabs 221 overlap with each other. Also, the tab bundle 230 may include a facing portion where the plurality of first tabs 211 extending from the first overlapping portion and the plurality of second tabs 221 extending from the second overlapping portion face each other, a connection portion extending from the facing portion, and a bent portion disposed between the facing portion and the connection portion, at which the plurality of first tabs 211 and the plurality of second tabs 221 are bent.

For example, the first electrode assembly 210 may have a plurality of tabs aligned to form a first tab bundle 212. Also, the second electrode assembly 220 may have a plurality of tabs aligned to form a second tab bundle 222. The first tab bundle 212 and the second tab bundle 222 may each be welded to the current collector 300.

For example, the wound first electrode assembly 210 and the second electrode assembly 220 each have a plurality of tabs protruding from the respective electrode plates to one side, and the plurality of tabs are aligned and arranged to form the first tab bundle 212 and the second tab bundle 222, respectively, and as described below, the plurality of tabs 211 and 221 may be welded to a surface 301 of the current collector 300 in the form of tab bundles 212 and 222.

Meanwhile, although the wound electrode assemblies 210 and 220 have been described so far, the same configuration described above can be equally applied to a stacked type electrode assembly including a plurality of electrode laminates.

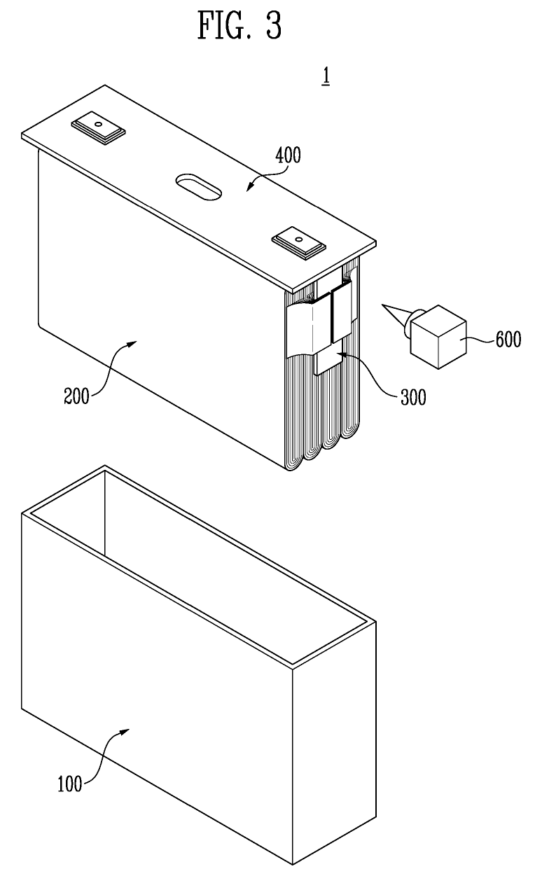

FIG. 3 is a perspective view schematically illustrating welding of the first tab bundle 212 and the second tab bundle 222 of the electrode assemblies 210 and 220 to the current collector 300 according to an embodiment of the present disclosure.

For example, when a surface opposite to a surface facing a side surface of the plurality of electrode assemblies 210 and 220 of the current collector 300 is defined as a surface 301 of the current collector 300, the current collector 300 may be electrically connected to the first tab bundle 212 or the second tab bundle 222 by a laser welding device 600 at the surface 301.

For example, for welding of the first tab bundle 212 or the second tab bundle 222 with the current collector 300, as illustrated in FIGS. 1 and 2, the plurality of tabs 211 and 221 may be gathered to one side to form the first tab bundle 212 or the second tab bundle 222, the formed first tab bundle 212 or the second tab bundle 222 may be collectively bent to one side, and then laser welding may be performed in close contact with the surface 301 of the current collector 300. However, as the thickness of the plurality of electrode assemblies 210 and 220 increases, the number of the plurality of tabs forming the aligned bundle increases, and accordingly, a tab disposed at an outermost position from the current collector 300 may be subjected to tension greater than that of a tab disposed on an inner side due to pressure applied during laser welding or an external force after laser welding.

Also, since a tab disposed at an innermost position from the current collector 300 is bent to a greater extent with respect to the current collector 300, there is a possibility that folding of the tab may occur. Accordingly, through the various welding methods according to an embodiment of the present disclosure, the problem of the outermost tab being torn due to excessive tension or the problem of the innermost tab being torn due to excessive bending causing a folded portion can be addressed.

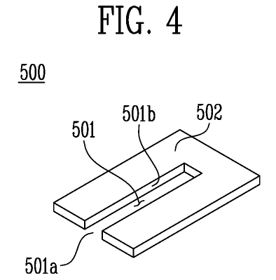

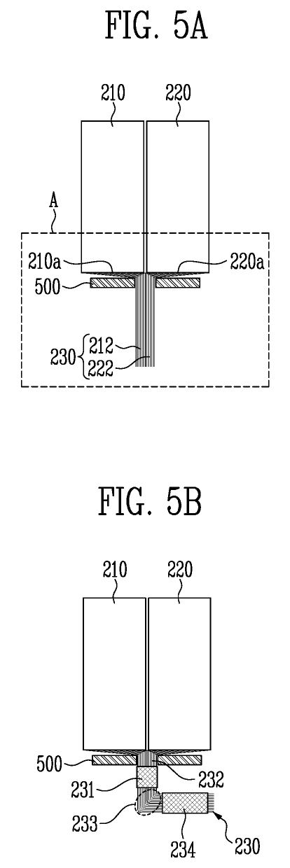

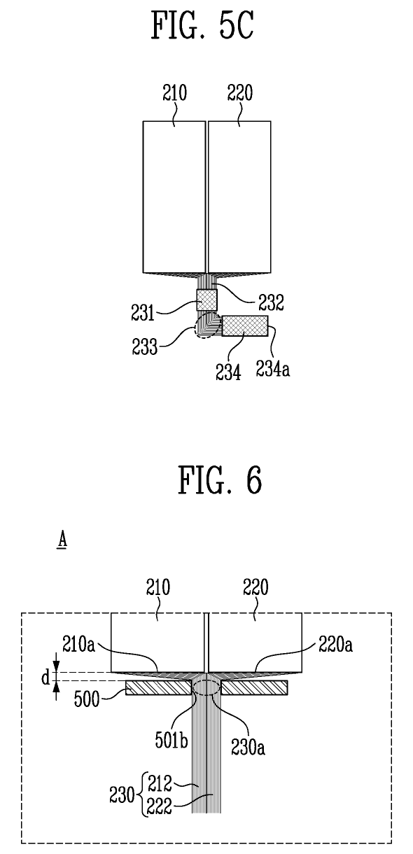

FIG. 4 is a perspective view schematically illustrating a welding guide 500 according to an embodiment of the present disclosure. Also, FIGS. 5A-5C are schematic diagrams schematically illustrating formation of a first preliminary welding portion 231 and a second preliminary welding portion 234 according to an embodiment of the present disclosure. Also, FIG. 6 is an enlarged view of a portion A of FIG. 5A.

In an embodiment of the present disclosure, the tab bundle 230 may include an overlapping portion including a first overlapping portion where the plurality of first tabs 211 overlap with each other and a second overlapping portion where the plurality of second tabs 221 overlap with each other, a facing portion where the plurality of first tabs 211 extending from the first overlapping portion and the plurality of second tabs 221 extending from the second overlapping portion face each other, a connection portion extending from the facing portion, and a bent portion disposed between the facing portion and the connection portion, at which the plurality of first tabs 211 and the plurality of second tabs 221 are bent. Also, the connection portion may be electrically connected to the cap assembly 400.

Also, in an embodiment of the present disclosure, the preliminary welding portion 231 and 234 may further include a first preliminary welding portion 231 formed by welding the plurality of first tabs 211 and the plurality of second tabs 221 in at least a partial region of the facing portion, and a second preliminary welding portion 234 formed by welding the plurality of first tabs 211 and the plurality of second tabs 221 in at least a partial region of the connection portion. Also, the bent portion may be disposed between the first preliminary welding portion 231 and the second preliminary welding portion 234, and the second preliminary welding portion 234 may be electrically connected to the cap assembly 400.

Hereinafter, in the battery assembly 1 according to an embodiment of the present disclosure including a current collecting structure, a welding method of the electrode assembly bundle 200 and the current collector 300 will be described in detail.

For example, as illustrated in FIG. 4, the battery assembly 1 may form the tab bundle 230 by converging and orienting the first tab bundle 212 of the first electrode assembly 210 and the second tab bundle 222 of the second electrode assembly 220 so as to face each other.

For example, the plurality of tabs of the first electrode assembly 210 may be aligned and gathered to form the first tab bundle 212, and the plurality of tabs of the second electrode assembly 220 may be aligned and gathered to form the second tab bundle 222.

Also, the first tab bundle 212 and the second tab bundle 222 may be converged and oriented to face each other in a direction in which the first electrode assembly 210 and the second electrode assembly 220 face each other to form one tab bundle 230.

For example, the laser welding device 600 may further include a welding guide 500 configured to support the tab bundle 230.

As illustrated in FIG. 4, the battery assembly 1 can readily weld the tab bundle 230 to the surface 301 of the current collector 300 using the welding guide 500.

For example, the welding guide 500 is a plate including a slit 501 open at one side, and the plate may be disposed in parallel with end portions of the first electrode assembly 210 and the second electrode assembly 220.

As illustrated in FIGS. 5A and 6, when the welding guide 500 is configured as a plate 502 having a slit 501 open at one side 501a, the plate 502 may be disposed in parallel with a plane perpendicular to the longitudinal direction, and the tab bundle 230 may be guided by inserting the tab bundle 230 into the slit 501 in a form of laterally supporting an extension portion 232 of the tab bundle 230.

For example, the tab bundle 230 includes a support region 230a that is inserted into and supported by the slit 501, and the first preliminary welding portion 231 may be formed by welding a region subsequent to the support region 230a. Accordingly, the tab bundle 230 may include the first preliminary welding portion 231 at a position spaced apart from an end portion 210a of the first electrode assembly 210 and an end portion 220a of the second electrode assembly 220.

For example, as illustrated in FIG. 5B, a side wall 501b of the slit 510 of the welding guide 500 supports the support region 230a of the tab bundle 230, and the first preliminary welding portion 231 may be formed by welding a predetermined region range among portions exposed to an outside of the welding guide 500. That is, the first preliminary welding portion 231 of the tab bundle 230 may be formed at a position spaced apart from the respective end portions 210a and 220a of the first and second electrode assemblies 210 and 220.

In an embodiment of the present disclosure, the preliminary welding portion 231 and 234 may further include a first preliminary welding portion 231 formed by welding the plurality of first tabs 211 and the plurality of second tabs 221 in at least a partial region of the facing portion, and a second preliminary welding portion 234 formed by welding the plurality of first tabs 211 and the plurality of second tabs 221 in at least a partial region of the connection portion. Also, the bent portion may be disposed between the first preliminary welding portion 231 and the second preliminary welding portion 234.

For example, a distance from the respective end portions 210a and 220a of the first electrode assembly 210 and the second electrode assembly 220 to a back surface of the current collector 300 may be greater than a thickness of the welding guide 500.

For example, since the distance from the respective end portions 210a and 220a of the first electrode assembly 210 and the second electrode assembly 220 to the back surface of the current collector 300 is greater than the thickness of the welding guide 500, the plurality of tabs 211 and 221 can be prevented from being disconnected due to interference with a surface of the current collector 300 at a predetermined region d where the plurality of tabs 211 and 221 are flattened.

For example, the tab bundle 230 may include a second preliminary welding portion 234 formed by welding a predetermined region range from a distal end portion of the tab bundle 230.

In an embodiment of the present disclosure, the second preliminary welding portion 234 may include a cut portion 234a formed by cutting a region of the second preliminary welding portion 234.

For example, as illustrated in FIG. 5C, in order to trim a distal end portion of the tab bundle 230, the second preliminary welding portion 234 may form a cut portion 234a by cutting a distal end of the tab bundle 230.

For example, since the tab bundle 230 is already constrained by the first preliminary welding portion 231 and the second preliminary welding portion 234, even when the preliminary welding portion 231 and 234 is cut to form the cut portion 234a by a cutting device (not illustrated), such as a gripper, tension due to cutting is not transmitted to the tab bundle 230, thereby preventing tearing from occurring in the tabs.

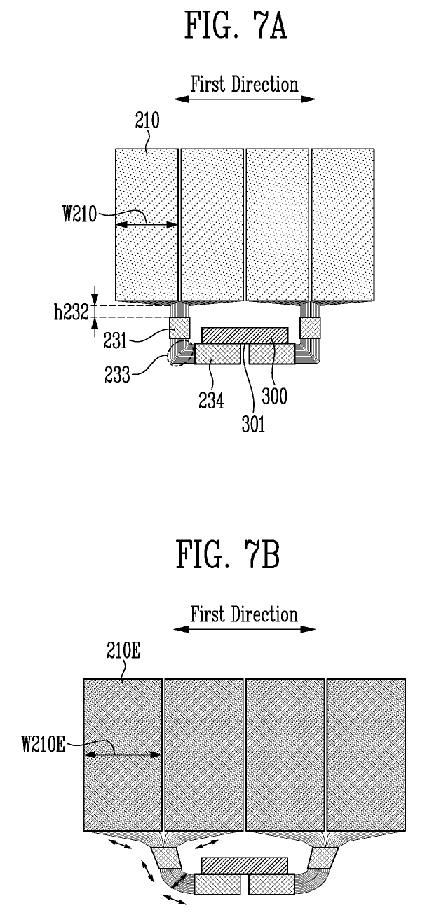

FIGS. 7A and 7B are schematic diagrams schematically illustrating welding of the tab bundle 230 to the current collector 300 according to an embodiment of the present disclosure, and expansion of the electrode assemblies 210 and 220.

In an embodiment of the present disclosure, the battery cell may further include a current collector 300 electrically connected to the cap assembly 400. The tab bundle 230 may include an overlapping portion including a first overlapping portion where the plurality of first tabs 211 overlap with each other and a second overlapping portion where the plurality of second tabs 221 overlap with each other, a facing portion where the plurality of first tabs 211 extending from the first overlapping portion and the plurality of second tabs 221 extending from the second overlapping portion face each other, a connection portion extending from the facing portion, and a bent portion disposed between the facing portion and the connection portion, at which the plurality of first tabs 211 and the plurality of second tabs 221 are bent. Also, the connection portion may be electrically connected to the current collector 300.

For example, as illustrated in FIG. 7A, by welding the second preliminary welding portion 234 to the surface 301 of the current collector 300, the first and second electrode assemblies 210 and 220 can be electrically connected to the current collector 300.

In an embodiment of the present disclosure, the preliminary welding portion 231 and 234 may further include a first preliminary welding portion 231 formed by welding the plurality of first tabs 211 and the plurality of second tabs 221 in at least a partial region of the facing portion, and a second preliminary welding portion 234 formed by welding the plurality of first tabs 211 and the plurality of second tabs 221 in at least a partial region of the connection portion. Also, the bent portion may be disposed between the first preliminary welding portion 231 and the second preliminary welding portion 234, and the second preliminary welding portion 234 may be electrically connected to the current collector 300.

For example, the tab bundle 230 may include a curved portion 233 disposed between the first preliminary welding portion 231 and the second preliminary welding portion 234.

For example, the tab bundle 230 may be bent to form the curved portion 233 between the first preliminary welding portion 231 and the second preliminary welding portion 234 so as to lift the second preliminary welding portion 234 onto the surface 301 of the current collector. Thereafter, while pressing with a welding mask (not illustrated) or the like, when a laser beam is irradiated onto the second preliminary welding portion 234 by, for example, a laser welding device, the current collector 300 and the second preliminary welding portion 234 may be welded while contacting each other.

For example, the curved portion 233 may refer to a C-shaped part formed by bending the tab bundle 230 inward toward the current collector 300.

For example, a height h232 from the end portions 210a and 220a of the first and second electrode assemblies 210 and 220 of the tab bundle 230 to a point where the first preliminary welding portion 231 starts is desirably greater than or equal to a thickness W210 of the electrode assemblies 210 and 220 in the first direction.

For example, as illustrated in FIG. 7B, even when the tab bundle 230 is welded to the current collector 300 using the first preliminary welding portion 231 and the second preliminary welding portion 234, during an aging period of the battery assembly 1, for example, the first electrode assembly 210 may expand such that the thickness W210 thereof increases by, for example, a predetermined ratio.

For example, when a thickness W210E of the expanded first electrode assembly 210E itself increases due to expansion caused by use or the like, since a distal end of the tab bundle 230 is welded to the current collector 300 and the position thereof is fixed, tension may be applied to tabs located at an extension portion 232 of the tab bundle 230, and there is a possibility that the tabs may be torn. Accordingly, in order to prevent the thickness W210E of the electrode assemblies 210 and 220 from increasing due to use of the battery assembly 1 and the tabs from being torn or disconnected, it is desirable to secure a buffer at a point when the tab bundle 230 is welded to the current collector 300.

For example, assuming that the thickness W210E of the expanded first electrode assembly 210E after expansion due to use or the like of the battery assembly 1 increases by a predetermined ratio α compared to the thickness W210 of the initial first electrode assembly 210, the height h232 from the end portions 210a and 220a of the first and second electrode assemblies 210 and 220 to a point where the first preliminary welding portion 231 starts may be set to be greater than or equal to α of the thickness W210 of the first and second electrode assemblies 210 and 220, thereby preventing tearing or disconnection of the plurality of tabs 211 and 212.

Meanwhile, an embodiment of the present disclosure can provide a method for manufacturing a battery cell. For example, the method for manufacturing a battery cell including: preparing a plurality of electrode assemblies 210 and 220 including a first electrode assembly 210 and a second electrode assembly 220; arranging the first electrode assembly 210 and the second electrode assembly 220 adjacent to each other in parallel; aligning a plurality of first tabs 211 protruding from one side or both sides of the first electrode assembly 210 and a plurality of second tabs 221 protruding from one side or both sides of the second electrode assembly 220 so as to face each other to form a tab bundle 230; and welding a partial region of the tab bundle 230 to form a preliminary welding portion 231 and 234.

For example, the preliminary welding portion 231 and 234 of the present disclosure may include: a first preliminary welding portion 231 formed by welding the plurality of first tabs 211 and the plurality of second tabs 221 in at least a partial region of the tab bundle 230; and a second preliminary welding portion 234 formed by welding the plurality of first tabs 211 and the plurality of second tabs 221 in a partial region spaced apart by a predetermined distance from the first preliminary welding portion 231 toward distal ends of the plurality of first tabs 211 and the plurality of second tabs 221.

Also, the method for manufacturing a battery cell of the present disclosure further includes: preparing a welding guide 500 including a slit 501 open at one side; and inserting the tab bundle 230 into the slit 501 while disposing the welding guide 500 in parallel with end portions of the first electrode assembly 210 and the second electrode assembly 220, and the first preliminary welding portion 231 may be formed by welding a region of the tab bundle 230 exposed to an outside of the welding guide 500.

For example, a distance from the end portions of the first electrode assembly 210 and the second electrode assembly 220 to the first preliminary welding portion 231 may be greater than or equal to a thickness change amount of the first electrode assembly 210 and the second electrode assembly 220 due to use of the battery cell.

Also, the second preliminary welding portion 234 may include a cut portion 234a formed by cutting a region of the second preliminary welding portion 234.

For example, the method for manufacturing a battery cell according to an embodiment of the present disclosure further includes: preparing an outer casing accommodating the first electrode assembly 210 and the second electrode assembly 220, and a cap assembly 400 coupled to one side of the outer casing; and electrically connecting a terminal portion of the cap assembly 400 and the second preliminary welding portion 234.

Also, the method further includes: preparing a current collector 300 for being connected with the first electrode assembly 210 and the second electrode assembly 220; and electrically connecting the second preliminary welding portion 234 to the current collector 300.

For example, the current collector 300 of the present disclosure is disposed between the first preliminary welding portion 231 and the second preliminary welding portion 234, the tab bundle 230 includes a curved portion 233 curved toward the current collector 300 between the first preliminary welding portion 231 and the second preliminary welding portion 234, and the second preliminary welding portion 234 may be electrically connected to a surface of the current collector 300.

The scope of the present disclosure is indicated by the claims set forth below rather than by the detailed description, and all changes or modifications derived from the meaning and scope of the claims and equivalents thereof are to be construed as being included in the scope of the present disclosure.

What is claimed is:

1. An electrode assembly bundle comprising:
a first electrode assembly;
a second electrode assembly arranged in parallel with the first electrode assembly; and
a tab bundle including a plurality of first tabs protruding from one side or both sides of the first electrode assembly and a plurality of second tabs protruding from one side or both sides of the second electrode assembly,
wherein the tab bundle includes a preliminary welding portion at which the plurality of first tabs and the plurality of second tabs are bonded to each other in a partial region of the tab bundle.

2. The electrode assembly bundle of claim 1, wherein the tab bundle comprises:
an overlapping portion including a first overlapping portion where the plurality of first tabs overlap with each other and a second overlapping portion where the plurality of second tabs overlap with each other;
a facing portion where the plurality of first tabs extending from the first overlapping portion and the plurality of second tabs extending from the second overlapping portion face each other;
a connection portion extending from the facing portion; and
a bent portion disposed between the facing portion and the connection portion, at which the plurality of first tabs and the plurality of second tabs are bent.

3. The electrode assembly bundle of claim 2, wherein the preliminary welding portion further comprises:
a first preliminary welding portion formed by welding the plurality of first tabs and the plurality of second tabs in at least a partial region of the facing portion; and
a second preliminary welding portion formed by welding the plurality of first tabs and the plurality of second tabs in at least a partial region of the connection portion,
wherein the bent portion is disposed between the first preliminary welding portion and the second preliminary welding portion.

4. The electrode assembly bundle of claim 3, wherein the second preliminary welding portion includes a cut portion formed by cutting a region of the second preliminary welding portion.

5. A battery cell comprising:
an outer casing;
at least one electrode assembly bundle according to claim 1 accommodated in the outer casing; and
a cap assembly coupled to one side of the outer casing.

6. The battery cell of claim 5, wherein the tab bundle comprises:
an overlapping portion including a first overlapping portion where the plurality of first tabs overlap with each other and a second overlapping portion where the plurality of second tabs overlap with each other;
a facing portion where the plurality of first tabs extending from the first overlapping portion and the plurality of second tabs extending from the second overlapping portion face each other;
a connection portion extending from the facing portion; and
a bent portion disposed between the facing portion and the connection portion, at which the plurality of first tabs and the plurality of second tabs are bent,
wherein the connection portion is electrically connected to the cap assembly.

7. The battery cell of claim 6, wherein the preliminary welding portion further comprises:
a first preliminary welding portion formed by welding the plurality of first tabs and the plurality of second tabs in at least a partial region of the facing portion; and
a second preliminary welding portion formed by welding the plurality of first tabs and the plurality of second tabs in at least a partial region of the connection portion,
wherein the bent portion is disposed between the first preliminary welding portion and the second preliminary welding portion, and
wherein the second preliminary welding portion is electrically connected to the cap assembly.

8. The battery cell of claim 5, further comprising a current collector electrically connected to the cap assembly,
wherein the tab bundle comprises:
an overlapping portion including a first overlapping portion where the plurality of first tabs overlap with each other and a second overlapping portion where the plurality of second tabs overlap with each other;
a facing portion where the plurality of first tabs extending from the first overlapping portion and the plurality of second tabs extending from the second overlapping portion face each other;
a connection portion extending from the facing portion; and
a bent portion disposed between the facing portion and the connection portion, at which the plurality of first tabs and the plurality of second tabs are bent,
wherein the connection portion is electrically connected to the current collector.

9. The battery cell of claim 8, wherein the preliminary welding portion further comprises:
a first preliminary welding portion formed by welding the plurality of first tabs and the plurality of second tabs in at least a partial region of the facing portion; and
a second preliminary welding portion formed by welding the plurality of first tabs and the plurality of second tabs in at least a partial region of the connection portion,
wherein the bent portion is disposed between the first preliminary welding portion and the second preliminary welding portion, and
wherein the second preliminary welding portion is electrically connected to the current collector.

10. A method for manufacturing a battery cell, the method comprising:
preparing a plurality of electrode assemblies including a first electrode assembly and a second electrode assembly;
arranging the first electrode assembly and the second electrode assembly adjacent to each other in parallel;
aligning a plurality of first tabs protruding from one side or both sides of the first electrode assembly and a plurality of second tabs protruding from one side or both sides of the second electrode assembly so as to face each other to form a tab bundle; and
welding a partial region of the tab bundle to form a preliminary welding portion.

11. The method of claim 10, wherein the preliminary welding portion comprises:
a first preliminary welding portion formed by welding the plurality of first tabs and the plurality of second tabs in at least a partial region of the tab bundle; and
a second preliminary welding portion formed by welding the plurality of first tabs and the plurality of second tabs in a partial region spaced apart by a predetermined distance from the first preliminary welding portion toward distal ends of the plurality of first tabs and the plurality of second tabs.

12. The method of claim 11, further comprising:
preparing a welding guide including a slit open at one side; and
inserting the tab bundle into the slit while disposing the welding guide in parallel with end portions of the first electrode assembly and the second electrode assembly,
wherein the first preliminary welding portion is formed by welding a region of the tab bundle exposed to an outside of the welding guide.

13. The method of claim 12, wherein a distance from the end portions of the first electrode assembly and the second electrode assembly to the first preliminary welding portion is greater than or equal to a thickness change amount of the first electrode assembly and the second electrode assembly due to use of the battery cell.

14. The method of claim 11, wherein the second preliminary welding portion includes a cut portion formed by cutting a region of the second preliminary welding portion.

15. The method of claim 14, further comprising:
preparing an outer casing accommodating the first electrode assembly and the second electrode assembly and a cap assembly coupled to one side of the outer casing; and
electrically connecting a terminal portion of the cap assembly and the second preliminary welding portion.

16. The method of claim 14, further comprising:
preparing a current collector configured to electrically connect with the first electrode assembly and the second electrode assembly; and
electrically connecting the second preliminary welding portion to the current collector.

17. The method of claim 16, wherein the current collector is disposed between the first preliminary welding portion and the second preliminary welding portion,
wherein the tab bundle includes a curved portion curved toward the current collector between the first preliminary welding portion and the second preliminary welding portion, and
wherein the second preliminary welding portion is electrically connected to a surface of the current collector.
